(19) United States
(12) Patent Application Publication
(10) Pub. No.: US 2026/0088695 A1
(43) Pub. Date: Mar. 26, 2026

(54) Elastic Recall Compensation for Magnetic Hysteresis Brakes

(71) Applicant: Safran Electronics & Defense, Avionics USA, LLC, Grand Prairie, TX (US)

(72) Inventor: Andrew Wright, MOISSY-CRAMAYEL (FR)

(73) Assignee: Safran Electronics & Defense, Avionics USA, LLC, Grand Prairie, TX (US)

(21) Appl. No.: 19/122,291

(22) PCT Filed: Nov. 10, 2022
(86) PCT No.: PCT/US2022/049526

§ 371 Date: Apr. 18, 2025

(51) Int. Cl. H02K 49/06

(52) U.S. Cl. CPC H02K 49/065

(57) ABSTRACT

Systems and devices are described for controlling equipment of a vehicle using a magnetic hysteresis assembly. The assembly preferably comprises a first plate having a hysteresis material and a second plate having a set of permanent magnets or an electromagnet. One or more mechanical clutches can be used to limit rotation of the hysteresis material with respect to the permanent magnets or the electromagnet. In this manner, elastic recall of the device can be limited or prevented due to the limitation in rotation of the first and second plates.

### FIELD OF THE INVENTION

The field of the invention is devices for controlling equipment of a vehicle and, in particular, magnetic hysteresis braking devices.

### BACKGROUND

The following description includes information that may be useful in understanding the present invention. It is not an admission that any of the information provided herein is prior art or relevant to the presently claimed invention, or that any publication specifically or implicitly referenced is prior art.

It is important for pilot controls to allows pilots to feel a force when using the controls. Mechanical friction braking forces have been used to control equipment while providing the feel force to the pilot. The friction braking forces are used to oppose movement of the control device in a controlled manner. Such devices often utilized a brake or friction pad, which contacts a portion of the control device, thereby resisting the force applied by the pilot to the control device. While effective, such mechanical friction devices wear over time and are highly susceptible to environmental, endurance, and aging variability.

The use of active force feedback systems is also known. However, such systems typically require complex electronics which adds to the cost, volume, and weight of the system. In addition, such systems require an electrical power interface and have increased failure potential due to their complexity.

To reduce overall maintenance requirements, passive braking systems have become more preferable. One example is the use of eddy current braking devices. These devices utilize eddy currents as a drag force to oppose movement of the control device and provide the feel force to the pilot. Since these devices do not utilize a brake or friction pad, there are no surface to wear or replace over time. However, the braking force of the devices are proportional to the relative velocity of the brake, meaning that the brake has no holding force when the control device is stationary. For this reason, a mechanical friction device must also be used to prevent unintentional movement of the control device in place when stationary.

It is also known to utilize magnetic hysteresis braking devices such as those described in U.S. Pat. No. 8,766,585 and U.S. Patent Publication No. 2016/0285352. However, such systems are generally prone to elastic recall (spring back) due to the permanent magnets realigning with the magnetized rotating hysteresis magnet, which can result in uncommanded motion. This could be resolved by increasing the overall size of the system such that the relative number of alternating poles per stroke is increased. However, the increased size increases the overall weight of the system and space requirements.

This problem has also been solved by incorporating a mechanical friction device, such as a friction pad, into the braking system. However, such solution reintroduces the disadvantages discussed above.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved magnetic hysteresis braking devices that reduce or eliminate elastic recall.

### SUMMARY OF THE INVENTION

The inventive subject matter provides apparatus, systems and methods utilizing magnetic hysteresis braking devices to control equipment of an aircraft or other vehicle, while mitigating some or all of the drawbacks discussed above. Contemplated devices comprise a magnetic friction assembly having at least a first plate and a second plate, which are each configured to rotate about a first axis. Preferably, the first axis is defined by a shaft that is connected to an output pinion, which can collectively be used to control the equipment.

The output pinion may be connected to a control lever, which is movable to control the equipment and provide force feedback to a pilot. As an example, the control lever could be a throttle, which when moved allows a pilot to control an engine.

As discussed above, the use of magnetic hysteresis braking devices advantageously eliminates the need for mechanical braking pads that wear over time. In addition, the braking torque of the device is independent of the relative velocity of the control lever and provides holding power when the control lever is at zero velocity such that the control lever does not move when not intended.

The first plate of the magnetic friction assembly preferably comprises a hysteresis material and the second plate preferably comprises a set of permanent magnets or an electromagnet. In this manner, the first and second plates can advantageously create a magnetic field between the first and second plates. The spacing between the first and second plates defines a first gap that acts as a magnetic shear zone. The movement of second plate relative to the first plate causes energy to be dissipated and generates forces that oppose rotation of the second plate.

It is contemplated that the properties of the magnetic field can be varied depending on the composition and size of the plates, the distance between the first and second plates, the number of strength of the permanent magnets, and/or by the electromagnet (when used).

Preferably, one or more mechanical clutches can be utilized to limit rotation of various components of the system. For example, a first mechanical clutch (i.e., a one-way clutch) can be used to limit rotation of the first plate in a first direction (e.g., counterclockwise). It is also contemplated that the first mechanical clutch can limit rotation of the second plate in a second direction (e.g., clockwise). The mechanical clutch advantageously limits movement of the components to thereby reduce or eliminate elastic recall.

Thus, the inventive subject matter can retain the advantages of passive magnetic hysteresis brake technology including the simplicity and immunity to environmental, endurance, and aging variability, while reducing or eliminating magnetic elastic spring back. This is accomplished by constraining the bi-directional pilot input motion to move the magnetic elements in one direction (and thereby constrain the motion at the magnetic shear gaps) with one-way clutches to prevent spring back displacement (elastic recall) of the inceptor (control lever).

The inventive subject matter discussed herein is distinct from prior art solutions known to Applicant because it does not re-introduce mechanical dynamic sliding friction for feel, nor does it rely on increasing the number of poles per rotation angle with higher design complexity of gearing or additional poles. Rather, the magnetic field arrangement can be optimized for size, weight, and force, and disregard the constraints of elastic recall minimization.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of one embodiment of a device that controls equipment of a vehicle using a magnetic hysteresis assembly.

FIG. 2 is a schematic of one embodiment of a mechanical clutch.

FIG. 3 is a schematic of another embodiment of a device that controls equipment of a vehicle using a magnetic hysteresis assembly.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

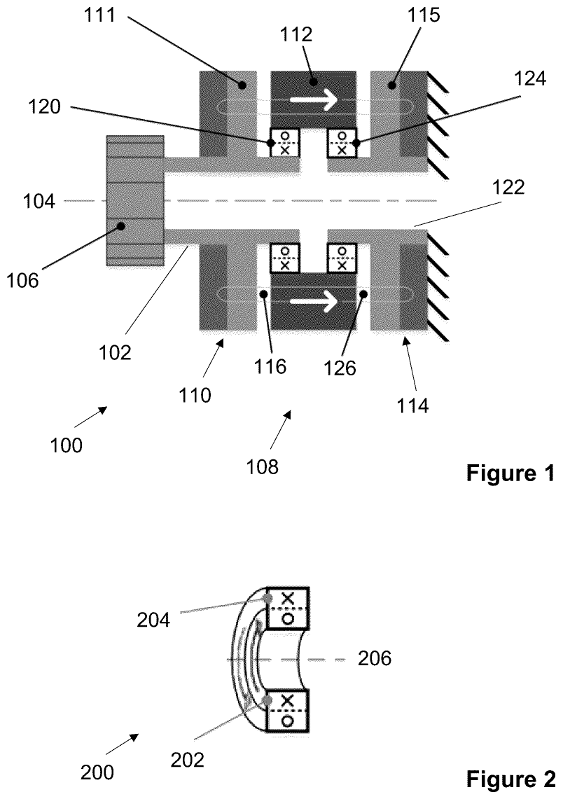

FIG. 1 illustrates one embodiment of a device 100 for an aircraft pilot inceptor that controls equipment of a vehicle. Device 100 comprises an input shaft 102 that defines a first axis 104. In some embodiments, the input shaft 102 may be coupled with an output pinion 106 that can be coupled with the pilot inceptor (control lever).

Device 100 preferably comprises a magnetic friction assembly 108 coupled to the input shaft 102. The magnetic friction assembly 108 comprises one or more components that may rotate with respect to one another. As shown in FIG. 1, the magnetic friction assembly 108 comprises a first plate 110, a second plate 112, and a third plate 114. Each of the first plate 110 and the second plate 112 may rotate about the first axis 104. The second plate 112 is disposed between the first plate 110 and the third plate 114.

It is contemplated that the first plate 110, the second plate 112, and the third plate 114 are substantially perpendicular to the first axis 104 and extend parallel to one another. Each of the plates 110, 112, 114 may comprise a disk having an aperture in the center and may be placed around the common first axis 104. The plates 110, 112, 114 may be identical in size.

The first plate 110 comprises a hysteresis material 111. The second plate 112 comprises a set of permanent magnets that generate a permanent magnetic field disposed on the second plate 112. In some embodiments, the permanent magnets may be alternate circumferentially on the second plate, such that adjacent magnets have opposite polarities. The array or set of permanent magnets exposes the hysteresis material 111 to varying magnetic fields as a result of the motion of the inceptor (control lever), output pinion 106, and shaft 102.

In alternative embodiments, it is contemplated that the second plate 112 could instead comprise an electromagnet capable of generating a variable magnetic field. In such embodiments, the second plate 112 may comprise at least one coil mounted on the second plate 112.

Preferably, the first plate 110 is disposed a distance apart from the second plate 112 to form a first gap 116, which functions as a magnetic shear zone.

Device 100 further comprises a first mechanical clutch 120 that constrains the relative motion of the first plate 110 in a first direction. In this manner, the clutch 120 can constrain the relative motion between the set of permanent magnets on the second plate 112 and the hysteresis material of the first plate 110. As shown, the first mechanical clutch 120 is coupled to the second plate 112 and the input shaft 102.

The first mechanical clutch 120 is configured to limit rotation of the second plate 112 in a second direction opposite of the first direction. Thus, as shown in FIG. 1, the clutch 120 limits rotation of the first plate 110 to only rotate counterclockwise about the first axis 104, while also limiting rotation of the second plate 112 to only rotate clockwise about the first axis 104.

Device 100 further comprises a second shaft 122 disposed along the first axis 104 that preferably is coincident with shaft 102. Unlike shaft 102, the second shaft 122 remains stationary relative to the first plate 110 and the second plate 112. The second shaft 122 is preferably coupled or affixed to the third plate 114.

A second mechanical clutch 124 is coupled to the second shaft 122 and the second plate 112, such that the clutch 124 limits rotation of the second plate 112 to only rotate clockwise about the first axis 104.

The third plate 114 preferably also comprises a hysteresis material 115. The array or set of permanent magnets on the second plate 112 exposes the hysteresis material 115 to varying magnetic fields as a result of the motion of the second plate 112. The space between the second plate 112 and the third plate 114 defines a second gap 126, which functions as a magnetic shear zone.

Thus, the first mechanical clutch 120 and the second mechanical clutch 124 collectively limit rotation of the second plate 112 (and the set of permanent magnets) to only clockwise about the first axis 104, and limit rotation of the first plate 110 (and hysteresis material 111) to only counterclockwise about the first axis 104.

Both the first mechanical clutch 120 and the second mechanical clutch 124 may comprise any commercially suitable clutch. Without limiting the foregoing, exemplary clutches include, for example, preloaded ball/roller ramps, wound binding springs, ratchet/pawls, sliding angular stops, and so forth. In choosing a mechanical clutch, it is important to minimize the lash in the reverse direction to be significantly less than the elastic recall.

As shown in FIG. 2, a mechanical clutch 200 comprises an inner race 202 and an outer race 204. In the configuration shown, the outer race 204 is configured to only rotate clockwise about a first axis 206 (as seen from left side), and the inner race 202 is configured to only rotate counterclockwise about the first axis 206 (as seen from left side). For visualization purposes, the “O” indicates an arrow coming out of the page, while the “X” indicates an arrow going into the page.

Mechanical clutches 120 and 124 preferably have an inner race and an outer race similar to the clutch 200 shown in FIG. 2. As shown in FIG. 1, the second plate 112 can be coupled to the outer race of the first mechanical clutch 120 and the shaft 102 can be coupled with the inner race of the first mechanical clutch 120. The second plate 112 can also be coupled to the outer race of the second mechanical clutch 124 and the second shaft 122 can be coupled with the inner race of the second mechanical clutch 124.

As discussed with respect to FIG. 2, it is contemplated that the inner race of the first mechanical clutch 120 is configured to only rotate counterclockwise about the first axis 104 (as seen from left side), while the outer race of the first mechanical clutch 120 is configured to only rotate clockwise about the first axis 104 (as seen from left side). It is further contemplated that the inner race of the second mechanical clutch 124 is configured to only rotate counterclockwise about the first axis 104 (as seen from left side), while the outer race of the second mechanical clutch 124 is configured to only rotate clockwise about the first axis 104 (as seen from left side).

Thus, by incorporating the mechanical clutches 120 and 124, the hysteresis material 111 of the first plate 110 only rotates counterclockwise with respect to the magnets of the second plate 112. The mechanical clutches 120 and 124 also limit rotation of the magnets of the second plate 112 to only rotate clockwise about the first axis 104 with respect to the hysteresis material 111 and 115.

Optionally, the first plate 110 and the third plate 114 can include a back iron such as a carbon-steel cylinder to increase the magnetic flux.

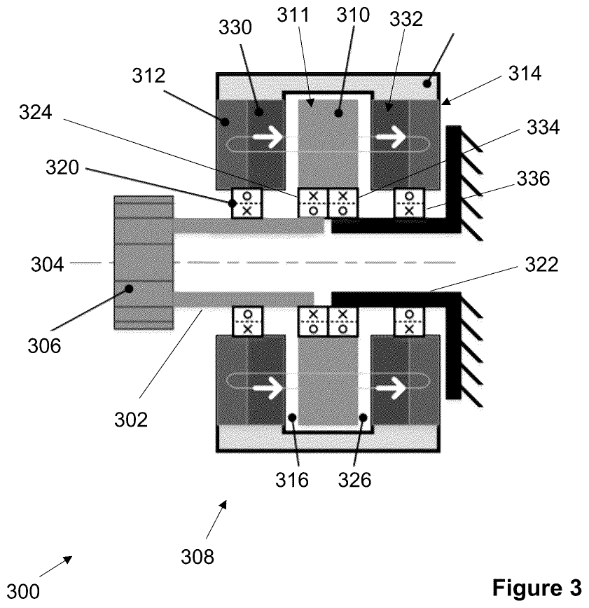

FIG. 3 illustrates another embodiment of a device 300 for an aircraft pilot inceptor that controls equipment of a vehicle. Device 300 comprises an input shaft 302 that defines a first axis 304. In some embodiments, the input shaft 302 may be coupled with an output pinion 306 that can be coupled with the pilot inceptor (control lever).

Device 300 preferably comprises a magnetic friction assembly 308 coupled to the input shaft 302. The magnetic friction assembly 308 comprises one or more components that may rotate with respect to one another. As shown in FIG. 3, the magnetic friction assembly 308 comprises a first plate 310, a second plate 312, and a third plate 314. Each of the first plate 310, second plate 312, and third plate 314 may rotate about the first axis 304. The first plate 310 is disposed between the second plate 312 and the third plate 314.

It is contemplated that the first plate 310, second plate 312, and third plate 314 are substantially perpendicular to the first axis 304 and extend parallel to one another.

The first plate 310 comprises a hysteresis material 311. The second plate 112 comprises a first set of permanent magnets 330 that generate a permanent magnetic field disposed on the second plate 312. In some embodiments, the permanent magnets may alternate circumferentially on the second plate 312, such that adjacent magnets have opposite polarities. The array or set of permanent magnets 330 exposes the hysteresis material 311 to varying magnetic fields as a result of the motion of the inceptor (control lever), output pinion 306, and shaft 302.

The third plate 314 may comprise a second set of permanent magnets 332 that generate a permanent magnetic field disposed on the third plate 314. In some embodiments, the permanent magnets may alternate circumferentially on the third plate 314, such that adjacent magnets have opposite polarities.

In alternative embodiments, it is contemplated that the second plate 312 and/or the third plate 314 could instead comprise an electromagnet capable of generating a variable magnetic field. In such embodiments, the electromagnet may comprise at least one coil mounted on the second plate 312 and/or the third plate 314.

Preferably, the first plate 310 is disposed a distance apart from the second plate 312 to form a first gap 316, which functions as a magnetic shear zone. The space between the second plate 312 and the third plate 314 defines a second gap 326, which functions as a magnetic shear zone.

Device 300 further comprises a first mechanical clutch 320 that constrains the relative motion of the second plate 312 in a first direction. In this manner, the clutch 320 can constrain the relative motion between the set of permanent magnets 330 on the second plate 312 and the hysteresis material 311 of the first plate 310. As shown, the first mechanical clutch 320 is coupled to the second plate 312 and the input shaft 302.

Device 300 also comprises a second mechanical clutch 324 that constrains the relative motion of the first plate 310 in a second direction opposite of the first direction. In this manner, the clutch 324 can constrain the relative motion between the set of permanent magnets 330 on the second plate 312 and the hysteresis material 311 of the first plate 310. As shown, the second mechanical clutch 324 is coupled to the first plate 310 and the input shaft 302.

Thus, as shown in FIG. 3, the first mechanical clutch 320 limits rotation of the second plate 312 to only rotate clockwise about the first axis 304 (as seen from left side). The second mechanical clutch 324 limits rotation of the first plate 310 to only rotate counterclockwise about the first axis 304 (as seen from left side).

Device 300 further comprises a second shaft 322 disposed along the first axis 304 that preferably is coincident with shaft 302. Unlike shaft 302, the second shaft 322 remains stationary relative to the first plate 310, the second plate 312, and the third plate 314.

A third mechanical clutch 334 is also coupled to the first plate 310 and is coupled to the second shaft 322, such that the clutch 334 limits rotation of the first plate 310 to only rotate counterclockwise about the first axis 304 (as seen from left side).

A fourth mechanical clutch 336 is coupled to the second shaft 322 and the third plate 314, such that the clutch 336 limits rotation of the third plate 314 to only rotate clockwise about the first axis 304 (as seen from left side).

Thus, as shown in FIG. 3, the third mechanical clutch 334 limits rotation of the first plate 310 to only rotate counterclockwise about the first axis 304 (as seen from left side). The fourth mechanical clutch 336 limits rotation of the third plate 314 to only rotate clockwise about the first axis 304 (as seen from left side).

Thus, the second mechanical clutch 324 and the third mechanical clutch 334 collectively limit rotation of the first plate 310 (and the hysteresis material 311) to only rotate counterclockwise about the first axis 304. The first mechanical clutch 320 and the fourth mechanical clutch 336 collectively limit rotation of the second plate 312 and the third plate 314 (and the first and second sets of permanent magnets 330, 332) to only rotate clockwise about the first axis 304.

Each of the first mechanical clutch 320, the second mechanical clutch 324, the third mechanical clutch 334, and the fourth mechanical clutch 336 may comprise any commercially suitable clutch, such as those discussed above. Without limiting the foregoing, exemplary clutches include, for example, preloaded ball/roller ramps, wound binding springs, ratchet/pawls, sliding angular stops, and so forth. In choosing a mechanical clutch, it is important to minimize the lash in the reverse direction to be significantly less than the elastic recall.

As discussed above in relation to FIG. 2, some or all of the first mechanical clutch 320, the second mechanical clutch 324, the third mechanical clutch 334, and the fourth mechanical clutch 336 may comprise an inner race and an outer race.

As shown in FIG. 3, the second plate 312 can be coupled to the outer race of the first mechanical clutch 320 and the shaft 302 can be coupled with the inner race of the first mechanical clutch 320. The first plate 310 can be coupled to the outer race of each of the second mechanical clutch 324 and the third mechanical clutch 334. The shaft 302 can be coupled to the inner race of the second mechanical clutch 324 and the second shaft 322 can be coupled with the inner race of the third mechanical clutch 334. The third plate 314 can be coupled to the outer race of the fourth mechanical clutch 336 and the second shaft 322 can be coupled with the inner race of the fourth mechanical clutch 336.

For visualization purposes, the “O” indicates an arrow coming out of the page, while the “X” indicates an arrow going into the page.

Thus, by incorporating the mechanical clutches 324, 334, the hysteresis material 311 of the first plate 310 only rotates counterclockwise with respect to the magnets of the second plate 312 and the third plate 314. The mechanical clutches 320 and 336 also limit rotation of the magnets of the second plate 112 and the third plate 314 to only rotate clockwise about the first axis 304 with respect to the hysteresis material 311.

Preferably, the second plate 312 and the third plate 314 include a back iron such as a carbon-steel cylinder to increase the magnetic flux.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A device for controlling equipment of a vehicle, comprising:
an output pinion having a shaft that defines a first axis;
a control lever coupled to the output pinion;
a magnetic friction assembly coupled to the shaft and comprising a first plate and a second plate, wherein the first and second plates are configured to rotate about the first axis, and wherein the first plate comprises a hysteresis material and wherein the second plate comprises a set of permanent magnets or electromagnets;
wherein the first plate and the second plate are disposed apart from one another defining a first gap;
a mechanical clutch configured to limit rotation of the first plate in a first direction.

2. The device of claim 1, wherein the mechanical clutch is further configured to limit rotation of the second plate in a second direction opposite of the first direction.

3. The device of claim 2, wherein the first direction is counterclockwise, and the second direction is clockwise.

4. The device of claim 1, wherein the mechanical clutch is coupled to the first plate and the shaft.

5. The device of claim 1, further comprising:
a second shaft disposed along the first axis, wherein the second shaft is stationary relative to the first and second plates; and
a second mechanical clutch configured to limit rotation of the first plate in a first direction, wherein the second mechanical clutch is coupled to the first plate and the second shaft.

6. The device of claim 1, wherein the magnetic friction assembly further comprises:
a third plate comprising a second hysteresis material;
wherein the third plate is stationary relative to the first and second plates; and
wherein the third plate and the second plate are disposed apart from one another defining a second gap.

7. The device of claim 6, wherein the second plate is disposed between the first and third plates.

8. (canceled)

9. The device of claim 1, wherein the mechanical clutch comprises an inner race and an outer race, wherein the outer race only rotates clockwise about the first axis, and wherein the inner race only rotates counterclockwise about the first axis.

10. The device of claim 9, wherein the second plate is coupled to the outer race and the shaft is coupled to the inner race.

11. The device of claim 1, wherein the second plate is affixed to the shaft, such that the second plate rotates with the shaft.

12. The device of claim 1, wherein the first and second plates are substantially perpendicular to the first axis.

13. The device of claim 1, wherein the second plate comprises a set of permanent magnets disposed circumferentially about the first axis such that poles of the magnets alternate between adjacent magnets.

14. The device of claim 1, wherein the second plate comprises an electromagnet.

15. The device of claim 1, wherein the magnetic friction assembly further comprises:
a third plate comprising a second set of permanent magnets or electromagnets, wherein the third plate is configured to rotate about the first axis;
wherein the first plate is disposed between the second and third plates; and
wherein the third plate and the first plate are disposed apart from one another defining a second gap.

16. The device of claim 15, further comprising:
a second mechanical clutch configured to limit rotation of the second plate in a second direction, wherein the second mechanical clutch is coupled to the second plate and the shaft; and
wherein the mechanical clutch is coupled to the first plate and the shaft.

17. The device of claim 16, wherein the mechanical clutch comprises an inner race and an outer race, wherein the outer race only rotates counterclockwise about the first axis, and wherein the inner race only rotates clockwise about the first axis.

18. The device of claim 17, wherein the second mechanical clutch comprises an inner race and an outer race, wherein the outer race only rotates clockwise about the first axis, and wherein the inner race only rotates counterclockwise about the first axis.

19. The device of claim 16, further comprising:
a second shaft disposed along the first axis, wherein the second shaft is stationary relative to the first and second plates; and
a third mechanical clutch configured to limit rotation of the third plate in a second direction, wherein the third mechanical clutch is coupled to the third plate and the second shaft.

20. The device of claim 19, wherein the third mechanical clutch comprises an inner race and an outer race, wherein the outer race only rotates clockwise about the first axis, and wherein the inner race only rotates counterclockwise about the first axis.
